(19) United States
(12) Patent Application Publication
(10) Pub. No.: US 2025/0365132 A1
(43) Pub. Date: Nov. 27, 2025

(54) ENCRYPTION AND DECRYPTION METHOD USING A STREAM CIPHER BASED ON INTEGER-ORIENTED CRYPTOGRAPHIC PERMUTATIONS

(71) Applicants: Jianliang Zheng, Shanghai (CN); Evan Zheng, New York, NY (US)

(72) Inventors: Jianliang Zheng, Shanghai (CN); Evan Zheng, New York, NY (US)

(21) Appl. No.: 19/294,265

(22) Filed: Aug. 7, 2025

Related U.S. Application Data
(63) Continuation-in-part of application No. PCT/CN2024/071503, filed on Jan. 10, 2024.

(30) Foreign Application Priority Data
Feb. 8, 2023 (CN) 202310077754.6

(51) Int. Cl. H04L 9/06

(52) U.S. Cl. CPC H04L 9/065

(57) ABSTRACT

The present disclosure relates to a stream cipher encryption and decryption method based on integer-oriented cryptographic permutations, comprising: initializing an internal state; updating the initialized state using a given key; further updating the state using an initialization vector; generating keystreams via a keystream generation function; and refreshing the internal state each time the keystream generation function is invoked a specified times, continuing until the required keystream length is reached. The beneficial effects include: high encryption speed; a fast-forward function enabling instant access to any position in large files or long data streams for encryption or decryption; the ability to set a bounded random access time, and supporting fast or real-time access; support for operations in various modes with different security margins and encryption speeds; and efficient permutation operations, where groups of bytes or bits are pseudorandomly selected from integers and moved together using integer operations to enhance processing efficiency.

### RELATED APPLICATIONS

The present application is a Continuation-in-part Application of International Application No. PCT/CN2024/071503, filed on Jan. 10, 2024, which claims the priority of Chinese patent application 202310077754.6 filed on Feb. 8, 2023. The international application and the above-mentioned Chinese patent application are hereby incorporated by reference into the present application in their entireties.

### FIELD OF THE DISCLOSURE

The present disclosure belongs to the technical field of data encryption and decryption, and more specifically, it relates to an encryption and decryption method using a stream cipher based on integer-oriented cryptographic permutations (hereinafter referred to as SSC).

### BACKGROUND

Block ciphers have dominated the development of data encryption standards. That said, RC4, a stream cipher designed by Ron Rivest in 1987 and kept as a trade secret by RSA Security until it was leaked in 1994, was for a long period the most popular cipher. RC4 gradually phased out ever since flaws were found in its key scheduling algorithm and is now deprecated. Although new stream ciphers have been developed all the time, including the finalists of eStream project, their adoption has been slow, and none have come close to achieving the status that RC4 once held. In fact, the space once occupied by RC4 has largely been filled by a new data encryption standard AES. The need for high-speed and real-time data encryption rockets as we are now in the era of big data, with the emergence of numerous high-speed communication and storage technologies, such as 5G communication and solid-state drives. AES represents the cutting edge of block ciphers, celebrated for its elegant and efficient algorithm ranking among the fastest in its category. Still, it's inherently slower than stream ciphers. This limitation makes it difficult for AES to meet the demands of emerging applications that involve large data volumes and stringent latency requirements, such as 4K video streaming and real-time video conferencing. In this light AES is not the most suitable solution for high-speed and real-time data encryption and decryption.

It thus becomes critically important to develop an encryption method that is both significantly faster and highly secure.

### SUMMARY

The present invention aims to overcome the deficiencies of the prior art by providing an encryption and decryption method using a stream cipher based on integer-oriented cryptographic permutations.

This encryption and decryption method using a stream cipher based on integer-oriented cryptographic permutations comprises the following steps:
abbreviating the stream cipher based on integer-oriented cryptographic permutations as SSC;
for encryption: receiving a plaintext sequence; generating a keystream after an integrated SSC operation, given an original key (key), an initialization vector (IV), rounds of mixing (rom), rounds of generation (rog), and a state refresh threshold (srt); then performing an XOR operation between the plaintext sequence and the keystream generated to obtain a ciphertext sequence;
for decryption: receiving a ciphertext sequence; generating a keystream after an integrated SSC operation, given an original key (key), an initialization vector (IV), rounds of mixing (rom), rounds of generation (rog), and a state refresh threshold (srt); then performing an XOR operation between the ciphertext sequence and the keystream generated to obtain a plaintext sequence;
the specific method for generating the keystream via the integrated SSC operation is as follows:
initializing an internal state by means of an internal state reset function;
updating the internal state by means of an internal state update function utilizing the original key (key);
further updating the internal state, which has been updated by the original key (key), by means of the internal state update function utilizing the initialization vector (IV);
generating the keystream by means of a keystream generation function based on the given original key, initialization vector (IV), rounds of mixing (rom), rounds of generation (rog), and state refresh threshold (srt); refreshing the internal state by means of an internal state refresh function each time the keystream has been generated for srt times, until the generated keystream reaches a required length, at which point the integrated SSC operation is terminated.

In a preferred embodiment, the reset function configured to initialize the internal state at the commencement of the integrated SSC operation is resetInternalState(St), wherein St represents the internal state, said internal state St consisting of:
two 32-word arrays A and B, wherein the two 32-word arrays A and B are sometimes combined and used as a single 64-word array C;

one 32-byte array M; and
three words w, c₁, and c₂;

```
the function is specifically implemented as follows:
let word x = 0x0706050403020100;
iterate i from 0 to 31:
  St.A[i] = x,
  x = x + 0x0808080808080808;
```

St.A and St.B represent arrays A and B of the internal state St, respectively; St.A[0:3] represents the first four elements of array A; St.M represents array M of the internal state St; St.w, St.c₁, and St.c₂ represent the words w, c₁, and c₂ of the internal state St, respectively; and the symbol ⇐ denotes a memory copy operation; let:

$$St . B = St . A ,$$

$$St . M ⇐ St . A [ 0 : 3 ] ,$$

$$St . w = 0 ,$$

$$St . {c}_{1} = 0 ,$$

$$St . {c}_{2} = 0 ;$$

the resetting of the internal state St is completed, then return the reset internal state St.

In a preferred embodiment, the internal state update function employed for updating the initialized internal state by means of the original key (key) is applyKeyOrIV(key, szKey, St, rom), wherein the original key (key) is a byte array comprising szKey bytes, with szKey≤64; the function is specifically implemented as follows:

```
  let Kiv be a byte array comprising sz bytes, with sz ≤ 64;
  let i, j, k, l, p, q, r, and u each be a byte; let a, b, c, d, m, n, and pw each be a word; and
let pkiv be a word array;
  (pkiv, pw) = processKeyOrIV (Kiv, sz);
  (A, B, M, w, c₁, c₂) ↔ (St.A, St.B, St.M, St.w, St.c₁, St.c₂), where the symbol ↔
indicates that the more compact aliases are used equivalently in the expressions;
  perform 8 mixing operations on array A, array B, and array M:
    iterate p from 0 to 7:
      first, perform a mixing operation on array M:
      (a, b, c, d) ⇐ M,
      (m, n, u) = computeByteMask(w), where said function computeByteMask(w)
  is configured to compute a byte mask,
      (a, b, c, d) = mixWords(a, b, c, d, m, n, u),
      M ⇐ (a, b, c, d),
      perform a mixing operation on array A and array B:
        iterate q from 0 to 7:
          pw = pw + pkiv[q],
          u = q << 2,
          (i, j, k, l) = M[u : u + 3],
          iterate r from 0 to rom−1:
            pw = (pw <<< 9) ⊕ (((A[i] + A[j]) ⊕ A[k]) + A[l]),
            (m, n, u) = computeByteMask (pw),
            (A[i], A[j], A[k], A[l]) = mixWords(A[i], A[j], A[k], A[l], m, n,
        u),
            (i, j, k, l) = (M[i], M[j], M[k], M[l]),
            pw = pw + (((B[i] ⊕ B[j]) + B[k]) ⊕ B[l]),
            (m, n, u) = computeBitMask(pw), where said function
        computeBitMask (pw) is configured to compute a bit mask,
            (B[i], B[j], B[k], B[l]) = mixWords(B[i], B[j], B[k], B[l], m, n,
        u),
            (i, j, k, l) = (i, j, k, l) ⊕ M[r & 0x1f],
            repeat the above steps until the iterations for r from 0 to rom− 1,
        for q from 0 to 7, and for p from 0 to 7 are completed;
      update the other state variables:
        w = w + pw,
        (i, j, k, l) ⇐ pw & 0x1f1f1f1f,
        (c₁, c₂) = (c₁ + B[i] + B[j], c₂ + B[k] + B[l]),
  (c₁, c₂) = (c₁ | 0x05, c₂ | 0xa0),
  return the updated internal state St;
```

the function mixWords(w₁, w₂, w₃, w₄, m, n, u) is configured to mix a plurality of words by means of byte or bit permutation.

```
  In a preferred embodiment, the function processKeyOrIV(Kiv, sz) is specifically
implemented as follows:
    pad the byte array Kiv to 64 bytes by means of concatenation:
      i = sz,
      while i≤32:
        Kiv = Kiv || Kiv, where the symbol || denotes a data concatenation
    operation at the byte level,
        i = i << 1;
      if i < 64:
        i = 63 − i,
        Kiv ← Kiv || Kiv[0:i];
    compute the word pw by concatenation of sz:
pw = sz || sz || sz || sz || sz || sz || sz || sz,
      where sz represents the number of bytes comprised in the byte array Kiv;
      compute the word array pkiv:
        pkiv ⇐ kiv;
      let the constant tm = 0x95ac9329ac4bc9b5,
        x = tm;
        iterate i from 0 to 7:
          x = x + pw,
          x = x ⊕ pkiv[i], where the symbol ⊕ denotes a bitwise XOR
      operation;
          iterate j from 0 to 7:
            x = lfsr(x),
            pkiv[j] = pkiv[j] + x,
            repeat the above operations until the iteration for j is completed;
```

repeat the above operations until the iteration for i from 0 to 7 is completed, then return pkiv and pw.

```
  In a preferred embodiment, the register state transition function lfsr(x), which is called
within the function processKeyOrIV(Kiv, sz), is specifically implemented as follows:
    i = x & 1, where the symbol & denotes a bitwise AND operation,
    x = x >> 1, where the symbol >> denotes a right logical bitwise shift operation,
    if i ≠ 0:
      x = x ⊕ tm;
  return the value of x.
```

In a preferred embodiment:

```
  the byte mask computing function, computeByteMask(w), is specifically
implemented as follows:
      m = w & 0x0101010101010101,
      n = (m << 8) + 1,
      m = m − n,
      n = m̅,
      u = w >> 61,
      u = u << 3,
    return the values of m, n, and u;
```

```
  the bit mask computing function, computeBitMask(w), is specifically
implemented as follows:
      m = w,
      n = m,
      u = w >> 58,
    return the values of m, n, and u;
```

```
  the function mix Words(w₁, w₂, w₃, w₄, m, n, u) is specifically
implemented asimplemented as follows:
      w₁ = w₁ >>> u,
      w₃ = w₃ <<< u,
      wₜ = (w₁ & m) | (w₂ & n),
      w₂ = (w₂ & m) | (w₃ & n),
      w₃ = (w₃ & m) | (w₄ & n),
      w₄ = (w₄ & m) | (w₁ & n),
      w₁ = wₜ,
      m = m ⊕ (m >>> 32),
      n = m̅ ,
      w₂ = w₂ <<< u ,
      w₄ = w₄ >>> u ,
      t₁ = (w₂ & m) | (w₄ & n),
      t₂ = (w₃ & m) | (w₁ & n),
      t₃ = (w₄ & m) | (w₂ & n),
      t₄ = (w₁ & m) | (w₃ & n),
    return the values of t₁, t₂, t₃, and t₄.
```

In a preferred embodiment, when the initialized internal state is further updated by means of an initialization vector IV, the internal state update function employed is identical to applyKeyOrIV(key, szKey, St, rom), such that St=applyKeyOrIV(IV, szIV, St, rom); wherein IV is a byte array comprising szIV bytes, with szIV≤64.

```
  In a preferred embodiment, the keystream generation function, generate(St,
rom, rog), is specifically implemented as follows:
    (A, B, C, M, w, c₁, c₂) ↔ (St.A, St.B, St.C, St.M, St.w, St.c₁, St.c₂);
    w = reSeed(w);
  update the 128-bit counter (c₁, c₂) and the word w:
    c₁ = lfsr(c₁),
    if c₁ = 1, then:
      c₂ = lfsr(c₂),
    w = w + (c₁ ⊕ c₂);
  perform a mixing operation on the array M of the internal state St:
    (a, b, c, d) ⇐ M,
    (m, n, u) = computeByteMask(w),
    (a, b, c, d) = mixWords(a, b, c, d, m, n, u),
    M ⇐ (a, b, c, d);
  update the word w, mix array A and array B, and generate a keystream:
    iterate q from 0 to 7:
      u = q << 2,
      (i, j, k, l) = M[u : u + 3];
      iterate r from 0 to rom−1:
        (a, b, c, d) = (A[i], A[j], A[k], A[l]),
        w = (w <<< 9) ⊕ (((a + b) ⊕ c) + d),
        (m, n, u) = computeByteMask(w),
        (A[i], A[j], A[k], A[l]) = mixWords(a, b, c, d, m, n, u),
        (i, j, k, l) = (M[i], M[j], M[k], M[l]),
        (e, f, g, h) = (B[i], B[j], B[k], B[l]),
        w = w + (((e ⊕ f) + g ⊕ h),
        (m, n, u) = computeBitMask (w),
        (B[i], B[j], B[k], B[l]) = mixWords(e, f, g, h, m, n, u),
        (i, j, k, l) = (i, j, k, l) ⊕ M[r & 0x1f],
        repeat the above steps until the iteration for r from 0 to rom−1 is
    completed;
      iterate r from 0 to rog−1:
        iterate u from 0 to 7:
          v = u << 2,
          (a, b, c, d) = (a, b, c, d) ⊕ C[i + v : i + v + 3],
          (e, f, g, h) = (e, f, g, h) + C[j + v : j + v + 3],
          output the result of (((a, b, c, d) + A[v : v + 3]) ⊕ (e, f, g, h)) + B[v :
      v + 3],
          repeat the above steps until the iteration for u from 0 to 7 is
      completed;
          (i, j) = (i, j) ⊕ M[r & 0x1f],
```

repeat the above steps until the iteration for r from 0 to rog−1 is completed; repeat the above steps until the iteration for q from 0 to 7 is completed, then return the internal state St;
the aforementioned called function, reSeed( ), is specifically implemented as follows:
r=readCCC( ), where the function readCCC( ) is configured to read the current CPU clock cycle count into the word r, whereupon the word r is subjected to a mixing process,

$$r = r + ( r \text{<<<} 31 ) ,$$

$$r = r + ( r \text{<<<} 15 ) ,$$

$$r = r + ( r \text{<<<} 7 ) ,$$

if the system-on-a-chip (SoC) integrates a hardware random number generator, then:
   r=r+readRAND( ), where the function readRAND( ) is configured to read a random word from the output of the hardware random number generator and add the resulting value to the word r,
modify the input word w by means of r, and return the modified w:

$$w = w ⊕ r .$$

In a preferred embodiment, the refresh function refreshInternalState(St₀, rom, src), which is configured to refresh the internal state each time the keystream has been generated for srt times, is specifically implemented as follows:

```
    ctr = src,
    iterate i from 1 to 64:
      ctr = lfsr(ctr),
      repeat the above operation until the iteration for i from 1 to 64 is completed;
    a byte array IV is computed from ctr by the following operations,
    IV = ctr,
    iterate i from 1 to 7:
      ctr = lfsr(ctr),
      IV = IV ∥ ctr,
      repeat the above operations until the iteration for i is completed;
    St = St₀, where St₀ represents the internal state subsequent to initialization;
    St = applyKeyOrIV(IV, 64, St, rom);
  return St.
  In a preferred embodiment:
  if the state refresh threshold srt > 0, then:
    St₀ = St,
    gctr = 0, where gctr is a word;
  while the keystream generated by the keystream generation function has not
reached a predetermined length:
    if srt > 0, gctr > 0 and gctr % srt = 0, then:
      src = gctr ÷srt,
      St = refreshInternalState(St÷, rom, src);
  regardless of whether gctr > 0 and gctr % srt = 0, perform the following operation:
  gctr = gctr + 1.
```

The present invention provides several advantageous effects:

The present invention exhibits a superior processing speed. During testing on an Intel® Core™ i7 processor, the present invention is capable of encrypting one byte of data in approximately half of one clock cycle. In configurations where Single Instruction, Multiple Data (SIMD) internal instructions are available, the present invention can encrypt one byte in approximately one-quarter of one clock cycle. This processing speed is approximately 19.8 to 56.9 times faster than the Advanced Encryption Standard (AES) and approximately 6.1 to 16.7 times faster than Intel's AES New Instructions (AES-NI), a hardware-optimized implementation of AES.

The present invention provides for a fast-forward capability, which enables nearly instantaneous random access to any arbitrary position within a large file or a long data stream.[2] Subsequent to said access, data can be encrypted or decrypted at that specific position.

The present invention supports the configuration of an upper bound for data random access time. This feature prevents the access time from increasing proportionally with the length of the file or data stream, thereby enabling fast or real-time random access to files or data streams of any arbitrary size.

The present invention employs a cryptographic initialization algorithm that satisfies the Strict Avalanche Criterion (SAC) and a keystream generation algorithm that has been validated by the most rigorous statistical test suites. This ensures the generation of a high-quality keystream.

The present invention guarantees a minimum keystream period of 128 bits (2¹²⁸ approximately 3.40×10³⁸) and an average period of 2979 bits (2²⁹⁷⁹, approximately 5.87×10⁸⁹⁶). This effectively precludes the occurrence of short periods and the potential security vulnerabilities that may arise therefrom.

By configuring different values for rom and rog, the stream cipher of the present invention can operate in a plurality of modes, wherein each mode provides a different security strength and encryption speed. Preliminary cryptographic security analysis indicates that the SSC encryption method is resistant to various known attacks. The designed strength of SSC is 512 bits, which is approximately equivalent to a 256-bit quantum security level, rendering the invention quantum-safe. Furthermore, SSC exhibits superior performance in terms of statistical properties, speed, and period length when compared to most well-known pseudo-random number generators (PRNGs) typically employed in non-secure applications. Consequently, SSC is also highly suitable for use in said non-secure applications.

The present invention can function both as a stream cipher and as a pseudo-random number generator. When employed as a PRNG, it can operate in either a deterministic mode or a non-deterministic mode. In the non-deterministic mode, SSC functions analogously to a true random number generator (TRNG), capable of generating high-quality, non-reproducible pseudo-random numbers. These pseudo-random numbers are suitable for use as keys, initialization vectors, seeds, salts, and challenges in various cryptosystems.

The present invention, when performing permutation operations, diverges from conventional methods that serially move individual bytes or bits. Instead, a set of bytes or bits is selected from an integer in a pseudo-random manner and is subsequently moved as a single, collective unit by means of integer arithmetic, thereby enhancing efficiency.

The integer-oriented cryptographic permutation operation of the present invention can be employed to replace conventional cryptographic permutation operations utilized in other security systems, consequently improving the operational efficiency of said security systems.

### BRIEF DESCRIPTION OF THE DRAWINGS

FIG. 1 is a flowchart illustrating the overall encryption process of the present invention.

FIG. 2 is a flowchart illustrating the overall decryption process of the present invention.

FIG. 3 is a detailed flowchart of the encryption process of the present invention.

FIG. 4 is a detailed flowchart of the decryption process of the present invention.

FIG. 5 is a schematic diagram illustrating the continued updating of the internal state during the keystream generation process.

FIG. 6 is a schematic diagram illustrating the generation of the keystream over rog iterations.

FIG. 7 is a schematic diagram illustrating the extraction of bytes in accordance with a byte mask.

FIG. 8 is a schematic diagram illustrating the extraction of bits in accordance with a bit mask.

FIG. 9 is a schematic diagram illustrating the updating of the word w of the internal state when operating in the non-deterministic mode.

### DETAILED DESCRIPTION

The present invention will now be described in further detail in conjunction with the following embodiments. The description of the embodiments hereinafter is provided for the sole purpose of assisting in the understanding of the present invention. It should be noted that for a person of ordinary skill in the technical field, various modifications and improvements can be made to the present invention without departing from the principles thereof. Such modifications and improvements are intended to fall within the scope of the appended claims.

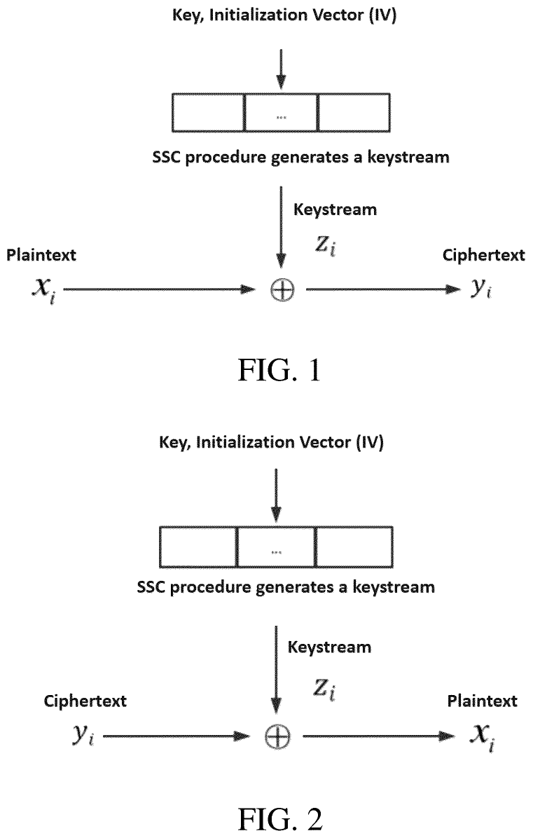

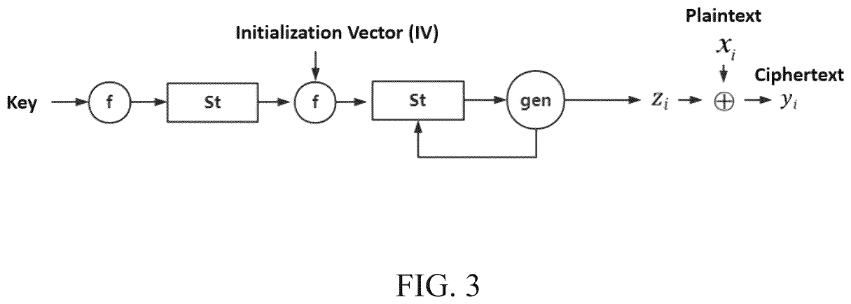

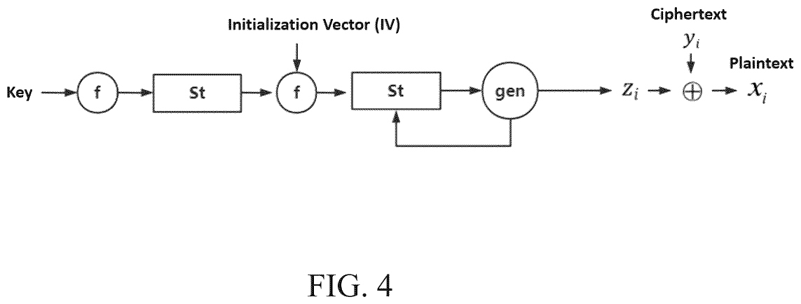

As an example, an encryption and decryption method using a stream cipher based on integer-oriented cryptographic permutations is specifically as follows:
let a plaintext sequence be denoted by xᵢ=x₀, x₁, x₂ . . . Xₙ and a ciphertext sequence be denoted by yᵢ=y₀, y₁, y₂ . . . yₙ, a keystream: zᵢ=z₀, z₁, z₂ . . . zₙ is generated after an original key (key) and an initialization vector (IV) are processed by the integrated SSC operation;
as illustrated in FIGS. 1 to 4, during encryption, the plaintext sequence and the keystream are subjected to a bitwise XOR operation; during decryption, the ciphertext sequence and the same keystream are subjected to a bitwise XOR operation; in the figures, the bitwise XOR operation is represented by the symbol ⊕, f represents a state update function, St represents an internal state, and gen represents a keystream generation function;
the encryption process is defined by: yᵢ=xᵢ⊕zᵢ;
the decryption process is defined by: xᵢ=yᵢ⊕zᵢ.

The process of generating the keystream via the integrated SSC operation essentially consists of two primary phases: (1) preliminary internal state initialization, where the internal state is first reset, subsequently updated by means of the key, and then further updated by means of the IV; and (2) keystream generation and output, during which the internal state is concurrently and continuously updated.

### (1) Preliminary Internal State Initialization

The reset function for initializing the internal state at the commencement of the integrated SSC operation is resetInternalState(St), wherein St represents the internal state, said internal state St consisting of:
two 32-word arrays A and B,
one 32-byte array M,
three words w, c₁, and c₂, where c₁ and c₂ are combined as a 128-bit counter,
the function is specifically implemented as follows:

$$let word x = 0 x 0706050403020100 ;$$

iterate i from 0 to 31:

$$St . A [ i ] = x ,$$

$$x = x + 0 x 0808080808080 \; 808 ;$$

St.A and St.B represent arrays A and B of the internal state St, respectively, St.A[0:3] represents the first four elements of array A, St.M represents array M of the internal state St; St.w, St.c₁, and St.c₂ represent the words w, c₁, and c₂ of the internal state St, respectively; and the symbol ⇐ denotes a memory copy operation, let:

$$St . B = St . A ,$$

$$St . M ⇐ St . A [ 0 : 3 ]$$

$$St . w = 0 ,$$

$$St . {c}_{1} = 0 ,$$

$$St . {c}_{2} = 0 ;$$

the resetting of the internal state St is complete, and return the reset internal state St.

The aforementioned operational process resets the internal state, St. Specifically it treats the two 32-word arrays, St.A and St.B as two 256-byte tables and initializes each of them to an identity permutation of size 256 (the value of each element in an identity permutation is equal to its index in the permutation), initializes the 32-byte array M to an identity permutation of size 32, and sets all other variables in St to 0. By way of example, St.A[0]=0x0706050403020100, then St.A[1]=St.A[0]+0x0808080808080808, St.A[2]=St.A[1]+0x0808080808080808, and so forth, until St.A[31]=St.A[30]+0x0808080808080808. The values of St.B are identical to the values of St.A. The values of St.M are initialized to the values of the first four words of St.A.

The method for first updating the internal state by means of the key, and subsequently for continuing the internal state update by means of the IV, is identical for both and is implemented as follows:
let the constant tm=0x95ac9329ac4bc9b5, and let Kiv be a byte array comprising sz bytes, where sz≤64;
let i, j, k, 1, p, q, r, and u each be a byte, and let a, b, c, d, m, n, and pw each be a word, and let pkiv be a word array;

```
(pkiv, pw) = processKeyOrIV(Kiv, sz);
(A, B, M, w, c₁, c₂) ↔ (St.A, St.B, St.M, St.w, St.c₁, St.c₂);
perform 8 mixing operations on array A, array B, and array M:
  iterate p from 0 to 7:
    first, perform a mixing operation on array M:
    (a, b, c, d) ⇐ M,
    (m, n, u) = computeByteMask(w), where said function
computeByteMask(w) is configured to compute a byte mask,
    (a, b, c, d) = mixWords(a, b, c, d, m, n, u),
    M ⇐ (a, b, c, d),
    perform a mixing operation on array A and array B:
      iterate q from 0 to 7:
        pw = pw + pkiv[q],
        u = q << 2,
        (i, j, k, l) = M[u : u + 3],
        iterate r from 0 to rom−1:
          pw = (pw <<< 9) ⊕ (((A[i] + A[j]) ⊕ A[k]) + A[l]),
          (m, n, u) = computeByteMask(pw),
          (A[i], A[j], A[k], A[l]) = mixWords(A[i], A[j], A[k],
      A[l], m, n, u),
          (i, j, k, l) = (M[i], M[j], M[k], M[l]),
          pw = pw + (((B[i] ⊕ B[j]) + B[k]) + B[l]),
          (m, n, u) = computeBitMask(pw), where said function
      computeBitMask (pw) is configured to compute a bit mask,
          (B[i], B[j], B[k], B[l]) = mixWords(B[i], B[j], B[k],
      B[l], m, n, u),
          (i, j, k, l) = (i, j, k, l) ⊕ M[r & 0x1f],
          repeat the above steps until the iterations for r from 0 to rom−1,
      for q from 0 to 7, and for p from 0 to 7 are completed;
    update the other state variables:
      w = w + pw,
      (i, j, k, l) ⇐ pw & 0x1f1f1f1f,
      (c₁, c₂) = (c₁ + B[i] + B[j], c₂ + B[k] + B[l]),
      (c₁, c₂) = (c₁ | 0x05, c₂ | 0xa0),
      return the updated internal state St;
```

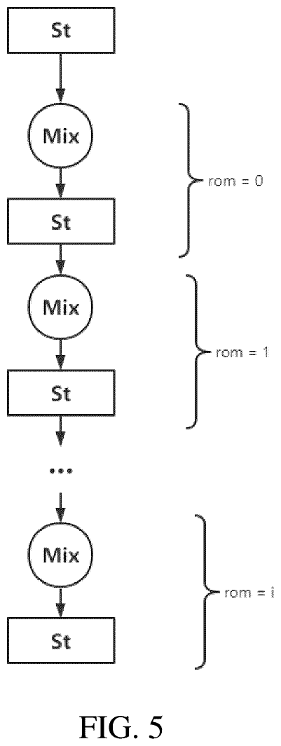

as illustrated in FIG. 5, the continued updating of the internal state during the keystream generation process is realized by the function mixWords(w₁, w₂, w₃, w₄, m, n, u), which is configured to mix a plurality of words by means of byte or bit permutation. The function mixWords(w₁, w₂,w₃, w₄, m, n, u) is specifically implemented as follows:

$${w}_{1} = {w}_{1} >>> u ,$$

$${w}_{3} = {w}_{3} \text{<<<} u ,$$

$${w}_{t} = ( {w}_{1} \& m ) \vert ( {w}_{2} \& n ) ,$$

$${w}_{2} = ( {w}_{2} \& m ) \vert ( {w}_{3} \& n ) ,$$

$${w}_{3} = ( {w}_{3} \& m ) \vert ( {w}_{4} \& n ) ,$$

$${w}_{4} = ( {w}_{4} \& m ) \vert ( {w}_{1} \& n ) ,$$

$${w}_{1} = {w}_{t} ,$$

$$m = m ⊕ ( m >>> 32 ) ,$$

$$n = \overline{m} ,$$

$${w}_{2} = {w}_{2} \text{<<<} u ,$$

$${w}_{4} = {w}_{4} >>> u ,$$

$${t}_{1} = ( {w}_{2} \& m ) \vert ( {w}_{4} \& n ) ,$$

$${t}_{2} = ( {w}_{3} \& m ) \vert ( {w}_{1} \& n ) ,$$

$${t}_{3} = ( {w}_{4} \& m ) \vert ( {w}_{2} \& n ) ,$$

$${t}_{4} = ( {w}_{1} \& m ) \vert ( {w}_{3} \& n ) ,$$

return the values of t₁, t₂, t₃, and t₄.

The aforementioned internal state initialization process updates the internal state St using a key or an initialization vector (IV), denoted by kiv, that is a byte array and contains sz bytes (sz≤64). The word rom (rounds of mixing) specifies the number of mixing operation cycles to be executed and is a cipher-wide security parameter.

The function processKeyOrIV(Kiv, sz), which is called by the aforementioned internal state initialization process, is specifically implemented as follows:

```
pad the byte array Kiv to 64 bytes by means of concatenation:
  i = sz,
  while i≤32:
    Kiv = Kiv ∥ Kiv,
    i = i << 1;
  if i < 64:
    i = 63 − i,
    Kiv ← Kiv ∥ Kiv[0:i];
compute pw by concatenation of sz:
  pw = sz ∥ sz ∥ sz ∥ sz ∥ sz ∥ sz ∥ sz ∥ sz,
  where sz represents the number of bytes comprised in the byte
  array Kiv; compute the word array pkiv:
    pkiv ⇐ kiv;
  let the constant tm = 0x95ac9329ac4bc9b5,
    x = tm;
    iterate i from 0 to 7:
      x = x + pw,
      x = x ⊕ pkiv[i],
      iterate j from 0 to 7:
        x = lfsr(x),
        pkiv[j] = pkiv[j] + x,
        repeat the above operations until the iteration for j is completed;
```

repeat the above operations until the iteration for i from 0 to 7 is completed, then return pkiv and pw.

### (2) Keystream Generation and Output, During Which the Internal State is Concurrently and Continuously Updated

The SSC stream cipher is designed to securely and efficiently output a high-quality keystream. During the keystream generation process, SSC continuously updates its internal state. This update process begins by subjecting the current state, St, to rom rounds of mixing. In each mixing round, a byte-level mixing is performed on the first table, St.A, followed by a bit-level mixing on the second table, St.B. Subsequent to the updating of the internal state, SSC executes rog cycles to output the keystream. The keystream generation function, generate(St, rom, rog), is specifically implemented as follows:

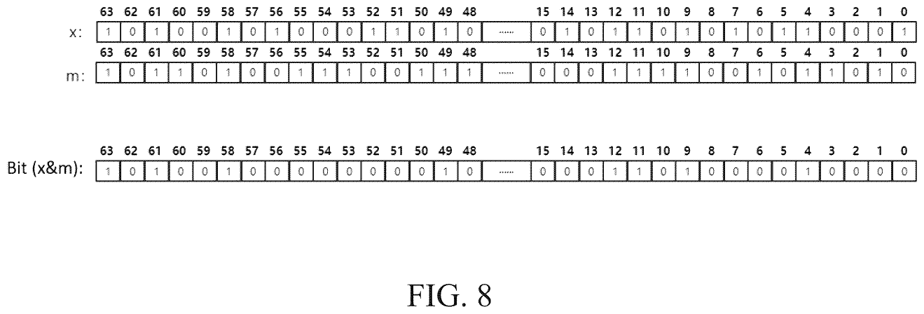

```
  (A, B, C, M, w, c₁, c₂) ↔ (St.A, St.B, St.C, St.M, St.w,St.c₁, St.c₂);
  w = reSeed(w);
update the 128-bit counter (c1, c2) and the word w:
  c₁ = lfsr(c₁),
  if c₁ = 1, then:
    c₂ = lfsr(c₂),
  w = w + (c₁ ⊕ c₂);
perform a mixing operation on the array M of the internal state St:
  (a, b, c, d) ⇐ M,
  (m, n, u) = computeByteMask(w),
  (a, b, c, d) = mixWords(a, b, c, d, m, n, u),
  M ⇐ (a, b, c, d);
update the word w, mix array A and array B, and generate a keystream:
  iterate q from 0 to 7:
    u = q << 2,
    (i, j, k, l) = M[u : u + 3];
    iterate r from 0 to rom−1:
      (a, b, c, d) = (A[i], A[j], A[k], A[l]),
      w = (w <<< 9) ⊕ (((a + b) ⊕ c) + d),
      (m, n, u) = computeByteMask(w),
      (A[i], A[j], A[k], A[l]) = mixWords(a, b, c, d, m, n, u),
      the process of extracting bytes during the mixing operation is
  illustrated in FIG. 7: suppose the input word X=0xA51A3B6D51235AB1,
  then subsequent to computation, m=0x0000FFFFFF00FFFF;
      (i, j, k, l) = (M[i], M[j], M[k], M[l]),
      (e, f, g, h) = (B[i], B[j], B[k], B[l]),
      w = w + (((e ⊕ f) + g) ⊕ h),
      (m, n, u) = computeBitMask(w),
      (B[i], B[j], B[k], B[l]) = mixWords(e, f, g, h, m, n, u), where the
  process of extracting bits during the mixing operation is illustrated in
  FIG. 8: suppose the input word X=0xA51A3B6D51235AB1, then subsequent to
  computation, m=0xB4E7D638CA831E5A;
      (i, j, k, l) = (i, j, k, l) ⊕ M[r & 0x1f],
      repeat the above steps until the iteration for r from 0 to rom−1 is
  completed;
    iterate r from 0 to rog−1:
      iterate u from 0 to 7:
        v = u << 2,
        (a, b, c, d) = (a, b, c, d) ⊕ C[i + v: i + v + 3],
        (e, f, g, h) = (e, f, g, h) + C[j + v : j + v + 3],
        output the result of (((a, b, c, d) + A[v : v + 3]) ⊕ (e, f, g, h)) +
    B[v : v + 3],
        repeat the above steps until the iteration for u from 0 to 7 is
    completed;
        (i, j) = (i, j) ⊕ M[r & 0x1f],
```

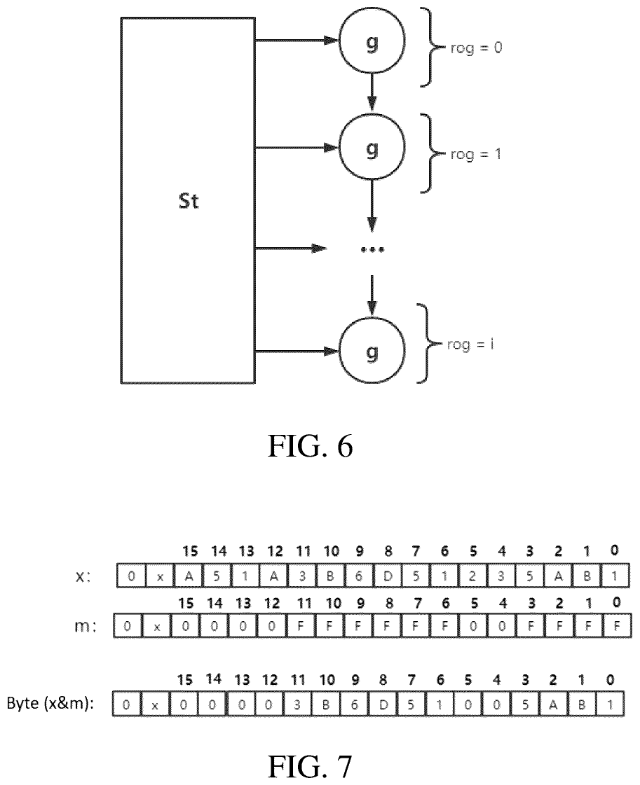

as illustrated in FIG. 6, repeat the above steps until the iteration for r from 0 to rog−1 is completed; repeat the above steps until the iteration for q from 0 to 7 is completed, then return the internal state St;
when the mixWords function utilizes a byte mask, the extraction operation is performed at the byte level (if a given byte within the mask m is FF, the corresponding byte of x is thereby selected; if a byte within the mask m is 00, the corresponding byte of x is masked off); when a bit mask is utilized, the extraction is performed at the bit level (if a bit within the mask m is 1, the corresponding bit in×is selected; if a bit within the mask m is 0, the corresponding bit in x is masked off);
the aforementioned called function, reSeed( ), is specifically implemented as follows:
r=readCCC( ), where the function readCCC( ) is configured to read the current CPU clock cycle count into the word r, whereupon the word r is subjected to a mixing process,

$$r = r + ( r \text{<<<} 31 ) ,$$

$$r = r + ( r \text{<<<} 15 ) ,$$

$$r = r + ( r \text{<<<} 7 ) ,$$

if the system-on-a-chip integrates a hardware random number generator, then:
   r=r+readRAND( ), where the function readRAND( ) is configured to read a random word from the output of the hardware random number generator and add the resulting value to the word r,
modify the input word w by means of r, and return the modified w:

$$w = w ⊕ r .$$

The keystream generation function, generate(St, rom, rog), may be repeatedly called to produce a keystream of a desired length. The word rom (rounds of mixing) specifies the number of mixing operation cycles to be executed. The byte rog (rounds of generation) specifies the number of keystream generation cycles to be executed subsequent to the mixing operation. Both rom and rog are cipher-wide security parameters.

The SSC stream cipher has a designed strength of 512 bits. The parameter rog is a single byte, and therefore its maximum value can be 255. Even in a configuration where rog is set to 255, the keystream output by SSC maintains a high level of quality and is indistinguishable from a true random number sequence when analyzed with current, prevalent statistical test suites. In practical applications, SSC adopts a conservative security policy, and it is recommended that the rog value not exceed 8.

srt indicates that the internal state is to be refreshed after every srt invocations of the function generate. Each time the internal state is refreshed, the following steps are executed: first, an Initialization Vector (IV) is computed based on src (state refreshing counter), wherein src represents the current invocation count of the function generate. Subsequently, the state St₀, which was preserved during the initialization process, is copied to the current state St. Finally, the computed IV is used as a parameter in a call to the function applyKeyOrIV to further update St. The refresh function refreshInternalState(St₀, rom, src), which is configured to refresh the internal state, is specifically implemented as follows:

```
  ctr = src,
  iterate i from 1 to 64:
    ctr = lfsr(ctr),
    repeat the above operation until the iteration for i from 1 to 64 is
  completed: compute a byte array IV from ctr by the following operations,
  IV = ctr,
  iterate i from 1 to 7:
    ctr = lfsr(ctr),
    IV = IV ∥ ctr,
    repeat the above operations until the iteration for i is completed;
  St = St₀, where St₀ represents the internal state subsequent to initialization;
  St = applyKeyOrIV(IV, 64, St, rom);
return St.
```

The function refreshInternalState provides a capability to transition directly to a corresponding internal state based on a given src value. The time required for this state transition does not increase as the value of src increases; that is, each transition requires a consistent and nearly instantaneous amount of time. In as much as consecutive invocations of the function refreshInternalState are separated by srt invocations of the function generate, this transition mechanism does not permit a jump to every individual state, but rather enables a jump to a discrete state interval. The size of each state interval is determined by srt. A smaller interval size corresponds to a lower upper bound for the time required to access any state within said interval. Consequently, the guaranteed data random access latency is smaller.

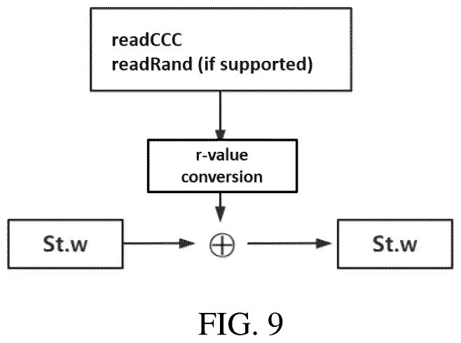

When the SSC stream cipher is operated in a non-deterministic mode, an update operation is performed on St.w. For example, on a system that supports the reading of true random numbers, the value of St.w can be determined by a true random value that has been read, thereby causing St.w to become non-reproducible, or in other words, to possess non-determinism. As St.w will serve as an input to the functions computeByteMask and computeBitMask for the computation of masks, the masks will consequently also possess non-determinism. With reference to FIG. 5, it is understood that the core of the mixWords operation is the use of St.w for mask computation and the corresponding word mixing operations. Therefore, the internal state subsequent to the mixWords operation will also become non-deterministic, and as a result, the final output generated will likewise possess non-determinism. The updating of the internal state in the non-deterministic mode is illustrated in FIG. 9.

As is understood from the implementation principle of SSC in the non-deterministic mode, SSC operating in said mode behaves analogously to a true random number generator. It can thereby be used in many applications, such as providing random keys for encryption and decryption, generating random numbers for lotteries or games, and supplying salts for password hashing operations. In contrast to a true random number generator, SSC operating in the non-deterministic mode exhibits higher speed, lower cost, and is more easily implemented.

As can be seen from Table 1 and Table 2 below, the SSC of the present invention is superior to existing algorithms in both keystream generation speed and data encryption speed. In Table 1 and Table 2, the notation SSC-m2g1 indicates that rom=2 and rog=1, and so forth. FF is an abbreviation for Fast Forwarding and indicates that the fast-forwarding speed was measured. All tests were performed on an Intel® Core™ i7 processor.

TABLE 1
Comparison of Keystream Generation Speed (Cycles/Byte)

| Keystream size(KB) | 1 | 10 | 100 | 1000 | 10000 |
|---|---|---|---|---|---|
| RC4 | 5.87 | 3.88 | 3.80 | 3.81 | 3.83 |
| HC-128 | 18.5 | 3.17 | 1.52 | 1.35 | 1.34 |
| Rabbit | 6.65 | 5.36 | 5.25 | 5.23 | 5.24 |
| Salsa20 | 6.51 | 5.94 | 5.84 | 5.83 | 5.90 |
| Sosemanuk | 13.6 | 3.13 | 2.02 | 1.91 | 1.90 |
| ChaCha8 | 7.22 | 2.8 | 2.35 | 2.30 | 2.30 |
| ChaCha12 | 8.11 | 3.79 | 3.34 | 3.29 | 3.29 |
| ChaCha20 | 10.09 | 5.77 | 5.31 | 5.27 | 5.28 |
| ZUC | 31.38 | 23.27 | 22.27 | 22.13 | 22.19 |
| SSC-m2g1 | 15.17 | 2.25 | 0.93 | 0.81 | 0.79 |
| SSC-m1g1 | 10.51 | 1.56 | 0.63 | 0.53 | 0.52 |
| SSC-m1g2 | 10.48 | 1.43 | 0.51 | 0.42 | 0.41 |
| SSC-m1g4 | 10.41 | 1.39 | 0.45 | 0.35 | 0.34 |
| SSC-m1g8 | 10.42 | 1.38 | 0.42 | 0.31 | 0.30 |
| SSC-m2g1 SSE2 | 15.39 | 2.24 | 0.91 | 0.77 | 0.76 |
| SSC-m1g1 SSE2 | 10.62 | 1.56 | 0.62 | 0.52 | 0.51 |
| SSC-m1g2 SSE2 | 10.41 | 1.42 | 0.49 | 0.39 | 0.38 |
| SSC-m1g4 SSE2 | 10.33 | 1.38 | 0.43 | 0.33 | 0.32 |
| SSC-m1g8 SSE2 | 10.37 | 1.36 | 0.39 | 0.28 | 0.27 |
| SSC-m2g1 AVX2 | 13.4 | 1.90 | 0.68 | 0.55 | 0.54 |
| SSC-m1g1 AVX2 | 9.33 | 1.27 | 0.44 | 0.35 | 0.35 |
| SSC-m1g2 AVX2 | 9.27 | 1.16 | 0.33 | 0.24 | 0.23 |
| SSC-m1g4 AVX2 | 9.26 | 1.14 | 0.28 | 0.18 | 0.18 |
| SSC-m1g8 AVX2 | 9.30 | 1.05 | 0.23 | 0.14 | 0.14 |
| SSC-m2g1 FF | 0.69 | 0.52 | 0.51 | 0.51 | 0.51 |
| SSC-m1g1 FF | 0.35 | 0.27 | 0.26 | 0.26 | 0.26 |
| SSC-m1gx FF | 0.35/x | 0.27/x | 0.26/x | 0.26/x | 0.26/x |

TABLE 2
Comparison of Data Encryption Speed (Cycles/Byte)

| Data stream size (KB) | 1 | 10 | 100 | 1000 | 10000 |
|---|---|---|---|---|---|
| RC4 | 5.89 | 3.90 | 3.82 | 3.83 | 3.85 |
| HC-128 | 19.25 | 3.50 | 1.84 | 1.67 | 1.66 |
| Rabbit | 6.70 | 5.57 | 5.41 | 5.31 | 5.34 |
| Salsa20 | 9.41 | 8.74 | 8.63 | 8.60 | 8.71 |
| Sosemanuk | 14.83 | 4.50 | 3.43 | 3.32 | 3.32 |
| ChaCha8 | 7.76 | 3.26 | 2.76 | 2.71 | 2.70 |
| ChaCha12 | 9.16 | 4.36 | 3.85 | 3.80 | 3.81 |
| ChaCha20 | 11.14 | 6.53 | 6.02 | 5.97 | 6.00 |
| AES(128 bit key) | 30.97 | 12.29 | 10.42 | 10.23 | 10.27 |
| AES (192 bit key) | 32.7 | 13.99 | 12.11 | 11.93 | 12.01 |
| AES (256 bit key) | 34.37 | 15.69 | 13.82 | 13.63 | 13.66 |
| AES_NI (128 bit key) | 3.82 | 3.23 | 3.18 | 3.17 | 3.17 |
| AES_NI(192 bit key) | 4.23 | 3.65 | 3.59 | 3.59 | 3.59 |
| AES_NI(256 bit key) | 4.48 | 4.05 | 4.01 | 4.00 | 4.00 |
| SM4 | 37.84 | 38.48 | 38.18 | 38.41 | 38.64 |
| ZUC | 31.66 | 23.68 | 22.68 | 22.55 | 22.57 |
| SSC-m2g1 | 15.61 | 2.46 | 1.11 | 0.98 | 0.96 |
| SSC-m1g1 | 10.67 | 1.74 | 0.81 | 0.70 | 0.69 |
| SSC-m1g2 | 10.64 | 1.64 | 0.70 | 0.60 | 0.59 |
| SSC-m1g4 | 10.62 | 1.58 | 0.63 | 0.53 | 0.52 |
| SSC-m1g8 | 10.64 | 1.57 | 0.61 | 0.51 | 0.50 |
| SSC-m2g1 SSE2 | 15.41 | 2.31 | 0.98 | 0.85 | 0.83 |
| SSC-m1g1 SSE2 | 10.72 | 1.62 | 0.69 | 0.60 | 0.59 |
| SSC-m1g2 SSE2 | 10.45 | 1.49 | 0.56 | 0.47 | 0.46 |
| SSC-m1g4 SSE2 | 10.37 | 1.44 | 0.51 | 0.40 | 0.39 |
| SSC-m1g8 SSE2 | 10.42 | 1.41 | 0.46 | 0.36 | 0.35 |
| SSC-m2g1 AVX2 | 14.02 | 1.95 | 0.73 | 0.61 | 0.60 |
| SSC-m1g1 AVX2 | 9.36 | 1.30 | 0.49 | 0.40 | 0.40 |
| SSC-m1g2 AVX2 | 9.33 | 1.18 | 0.38 | 0.30 | 0.29 |
| SSC-m1g4 AVX2 | 9.31 | 1.17 | 0.34 | 0.25 | 0.24 |
| SSC-m1g8 AVX2 | 9.35 | 1.09 | 0.30 | 0.21 | 0.20 |

1. An encryption and decryption method using a stream cipher based on integer-oriented cryptographic permutations, wherein the encryption and decryption method comprises the following steps:
abbreviating the stream cipher based on integer-oriented cryptographic permutations as SSC;
for encryption: receiving a plaintext sequence; generating a keystream after an integrated SSC operation, given an original key (key), an initialization vector (IV), rounds of mixing (rom), rounds of generation (rog), and a state refresh threshold (srt); then performing an XOR operation between the plaintext sequence and the keystream generated to obtain a ciphertext sequence;
for decryption: receiving a ciphertext sequence; generating a keystream after an integrated SSC operation, given an original key (key), an initialization vector (IV), rounds of mixing (rom), rounds of generation (rog), and a state refresh threshold (srt); then performing an XOR operation between the ciphertext sequence and the keystream generated to obtain a plaintext sequence;
the specific method for generating the keystream via the integrated SSC operation is as follows:
initializing an internal state by means of a reset function;
updating the internal state by means of an internal state update function, utilizing the original key (key);
further updating the internal state, which has been updated by the original key (key), by means of the internal state update function, utilizing the initialization vector (IV);
generating the keystream by means of a keystream generation function based on the given original key (key), initialization vector (IV), rounds of mixing (rom), rounds of generation (rog), and state refresh threshold (srt); refreshing the internal state by means of a refresh function each time the keystream generation function has been invoked for srt times, until the keystream generated reaches a required length.

2. The encryption and decryption method using a stream cipher based on integer-oriented cryptographic permutations according to claim 1, wherein the reset function configured to initialize the internal state at the commencement of the integrated SSC operation is resetInternalState(St), where St represents the internal state, said internal state St consisting of:
two 32-word arrays A and B;
one 32-byte array M; and
three words w, c₁, and c₂; an 8-bit unsigned integer is referred to as a byte; a 64-bit unsigned integer is referred to as a word;
the reset function is specifically implemented as follows:
let word x=0x0706050403020100;
iterate i from 0 to 31:
$$St . A [ i ] = x ,$$
$$x = x + 0 x 0808080808080 \; 808 ;$$
St.A and St.B represent arrays A and B of the internal state St, respectively; St.A[0:3] represents the first four elements of array A; St.M represents array M of the internal state St; St.w, St.c₁, and St.c₂ represent the words w, c1, and c2 of the internal state St, respectively; and the symbol ⇐ denotes a memory copy operation; let:
$$St . B = St . A ,$$
$$St . M ⇐ St . A [ 0 : 3 ]$$
$$St . w = 0 ,$$
$$St . {c}_{1} = 0 ,$$
$$St . {c}_{2} = 0 ;$$
the resetting of the internal state St is complete, then return the reset internal state St.

3. The encryption and decryption method using a stream cipher based on integer-oriented cryptographic permutations according to claim 2, wherein the internal state update function employed for updating the initialized internal state by means of the original key (key) is applyKeyOrIV(key, szKey, St, rom), wherein the original key (key) is a byte array comprising szKey bytes, where szKey≤64; the internal state update function is specifically implemented as follows:
let Kiv be a byte array comprising sz bytes, where sz≤64;
let i, j, k, 1, p, q, r, and u each be a byte; let a, b, c, d, m, n, and pw each be a word; and let pkiv be a word array;
```
(pkiv, pw) = processKeyOrIV(Kiv, sz);
(A, B, M, w, c₁, c₂) ↔ (St.A, St.B, St.M, St.w, St.c₁, St.c₂), where the
symbol ↔ is used to assign aliases to variables;
perform 8 mixing operations on array A, array B, and array M:
  iterate p from 0 to 7:
    first, perform a mixing operation on array M:
    (a, b, c, d) ⇐ M,
    (m, n, u) = computeByteMask(w), where said function computeByteMask(w) is
    configured to compute a byte mask,
    (a, b, c, d) = mixWords(a, b, c, d, m, n, u),
    M ⇐ (a, b, c, d),
    perform a mixing operation on array A and array B:
      iterate q from 0 to 7:
        pw = pw + pkiv[q],
        u = q << 2, where the symbol << denotes a left logical bitwise shift
        operation,
        (i, j, k, l) = M[u : u + 3],
        iterate r from 0 to rom−1:
          pw = (pw <<< 9) ⊕ (((A[i] + A[j]) ⊕ A[k]) + A[l]), where the
          symbol <<< denotes a left bitwise rotation operation,
          (m, n, u) = computeByteMask(pw),
          (A[i], A[j], A[k], A[l]) = mixWords(A[i], A[j], A[k], A[l], m, n, u),
          (i, j, k, l) = (M[i], M[j], M[k], M[l]),
          pw = pw + (((B[i] ⊕ B[j]) + B[k]) ⊕ B[l]),
          (m, n, u) = computeBitMask(pw), where said function
          computeBitMask(pw) is configured to compute a bit mask,
          (B[i], B[j], B[k], B[l]) = mix Words(B[i], B[j], B[k], B[l], m, n, u),
          (i, j, k, l) = (i, j, k, l) ⊕ M[r & 0x1f],
          repeat the above steps until the iterations for r from 0 to rom − 1, for
          q from 0 to 7, and for p from 0 to 7 are completed;
    update the other state variables:
      w = w + pw,
      (i, j, k, l) < pw & 0x1f1f1f1f,
      (c₁, c₂) = (c₁ + B[i] + B[j], c₂ + B[k] + B[l]),
      (c₁, c₂) = (c₁ | 0x05, c₂ | 0xa0),
      return the updated internal state St;
```
the function mixWords(w₁, w₂, w₃, w₄, m, n, u) is configured to mix a plurality of words by means of byte or bit permutation.

4. The encryption and decryption method using a stream cipher based on integer-oriented cryptographic permutations according to claim 3, wherein the function processKeyOrIV(Kiv, sz) is specifically implemented as:
```
  pad the byte array Kiv to 64 bytes by means of concatenation:
    i = sz,
    while i≤32:
      Kiv = Kiv ∥ Kiv, where the symbol ∥ denotes a data concatenation
operation at the byte level,
      i = i << 1;
    if i < 64:
      i = 63 − i,
      Kiv ← Kiv ∥ Kiv[0:i];
  compute the word pw by concatenation of sz:
    pw = sz ∥ sz ∥ sz ∥ sz ∥ sz ∥ sz ∥ sz ∥ sz,
    where sz represents the number of bytes comprised in the byte array Kiv;
    compute the word array pkiv:
      pkiv ⇐ kiv;
    let the constant tm = 0x95ac9329ac4bc9b5,
      x = tm;
      iterate i from 0 to 7:
        x = x + pw,
        x = x ⊕ pkiv[i], where the symbol ⊕ denotes a bitwise XOR operation;
        iterate j from 0 to 7:
          x = lfsr(x),
          pkiv[j] = pkiv[j] + x,
          repeat the above operations until the iteration for j is completed;
```
repeat the above operations until the iteration for i from 0 to 7 is completed, then return pkiv and pw.

5. The encryption and decryption method using a stream cipher based on integer-oriented cryptographic permutations according to claim 4, wherein the register state transition function lfsr(x), which is called within the function processKeyOrIV(Kiv, sz), is specifically implemented as follows:
i=x & 1, where the symbol & denotes a bitwise AND operation,
x=x>>1, where the symbol >> denotes a right logical bitwise shift operation, if i≠0:
x=x⊕tm;
return the value of x.

6. The encryption and decryption method using a stream cipher based on integer-oriented cryptographic permutations according to claim 3, wherein
```
  the byte mask computing function computeByteMask(w), is specifically implemented as
follows:
      m = w & 0x0101010101010101,
      n = (m << 8) + 1,
      m = m − n,
      n = m, where the symbol   denotes an inversion operation, which flips 0 and 1,
      u = w >> 61,
      u = u << 3,
    return the values of m, n, and u;
  the bit mask computing function, computeBitMask(w), is specifically implemented as
follows:
      m = w,
      n = m,
      u = w >> 58,
    return the values of m, n, and u;
  the function mix Words(w₁, w₂, w₃, w₄, m, n, u) is specifically implemented as follows:
      w₁ = w₁ >>> u, where the symbol >>> denotes a right bitwise rotation operation,
      w₃ = w₃ <<< u, where the symbol <<< denotes a left bitwise rotation operation,
      wₜ = (w₁ & m) | (w₂ & n), where the symbol | denotes a bitwise OR operation,
      w₂ = (w₂ & m) | (w₃ & n),
      w₃ = (w₃ & m) | (w₄ & n),
      w₄ = (w₄ & m) | (w₁ & n),
      w₁ = wₜ,
      m = m ⊕ (m >>> 32),
      n = m ,
      w₂ = w₂ <<< u,
      w₄ = w₄ >>> u,
      t₁ = (w₂ & m) | (w₄ & n),
      t₂ = (w₃ & m) | (w₁ & n),
      t₃ = (w₄ & m) | (w₂ & n),
      t₄ = (w₁ & m) | (w₃ & n),
    return the values of t₁, t₂, t₃, and t₄.
```

7. The encryption and decryption method using a stream cipher based on integer-oriented cryptographic permutations according to claim 3, wherein when the initialized internal state is further updated by means of an initialization vector IV, the internal state update function employed is identical to applyKeyOrIV(key, szKey, St, rom), such that St=applyKeyOrIV(IV, szIV, St, rom); wherein IV is a byte array comprising szIV bytes, where szIV≤64.

8. The encryption and decryption method using a stream cipher based on integer-oriented cryptographic permutations according to claim 7, wherein the keystream generation function, generate(St, rom, rog), is specifically implemented as follows:
```
  (A, B, C, M, w, c₁, c₂) ↔ (St.A, St.B, St.C, St.M, St.w,St.c₁, St.c₂);
  w = reSeed(w);
update the 128-bit counter (c1, c2) and the word w:
  c₁ = lfsr(c₁),
  if c₁ = ₁, then:
    c₂ = lfsr(c₂),
  w = w + (c₁ @ c₂);
perform a mixing operation on the array M of the internal state St:
  (a, b, c, d) ⇐ M,
  (m, n, u) = computeByteMask(w),
  (a, b, c, d) = mixWords(a, b, c, d, m, n, u),
  M ⇐ (a, b, c, d);
update the word w, mix array A and array B, and generate a keystream:
  iterate q from 0 to 7:
    u = q << 2,
    (i, j, k, l) = M[u : u + 3];
    iterate r from 0 to rom−1:
      (a, b, c, d) = (A[i], A[j], A[k], A[l]),
      w = (w <<< 9) ⊕ (((a + b) ⊕ c) + d),
      (m, n, u) = computeByteMask(w),
      (A[i], A[j], A[k], A[l]) = mixWords(a, b, c, d, m, n, u),
      (i, j, k, l) = (M[i], M[j], M[k], M[l]),
      (e, f, g, h) = (B[i], B[j], B[k], B[l]),
      w = w + (((e ⊕ f) + g) ⊕ h),
      (m, n, u) = computeBitMask(w),
      (B[i], B[j], B[k], B[l]) = mixWords(e, f, g, h, m, n, u),
      (i, j, k, l) = (i, j, k, l) ⊕ M[r & 0x1f],
      repeat the above steps until the iteration for r from 0 to rom−1 is completed;
    iterate r from 0 to rog−1:
      iterate u from 0 to 7:
        v = u << 2,
        (a, b, c, d) = (a, b, c, d) ⊕ C[i + v : i + v + 3],
        (e, f, g, h) = (e, f, g, h) + C[j + v : j + v + 3],
        output the result of (((a, b, c, d) + A[v : v + 3]) ⊕ (e, f, g, h)) + B[v : v +
        3],
        repeat the above steps until the iteration for u from 0 to 7 is completed;
        (i, j) = (i, j) ⊕ M[r & 0x1f],
  repeat the above steps until the iteration for r from 0 to rog−1 is completed;
  repeat the above steps until the iteration for q from 0 to 7 is completed, then return the
  internal state St;
  the aforementioned called function, reSeed( ), is specifically implemented as follows:
  r = readCCC( ), where the function readCCC( ) is configured to read the current CPU
  clock cycle count into the word r, whereupon the word r is subjected to a mixing
  process,
  r = r +(r <<< 31),
  r = r + (r <<< 15),
  r = r + (r <<< 7),
  if the system-on-a-chip integrates a hardware random number generator, then:
    r = r + readRAND( ), where the function readRAND( ) is configured to read a
    random word from the output of the hardware random number generator and add
    the resulting value to the word r,
  modify the input word w by means of r, and return the modified w:
  w = w ⊕ r.
```

9. The encryption and decryption method using a stream cipher based on integer-oriented cryptographic permutations according to claim 8, wherein the refresh function refreshInternalState(St₀, rom, src), which is configured to refresh the internal state each time the keystream generation function has been invoked for srt times, is specifically implemented as follows:
```
  ctr = src,
  iterate i from 1 to 64:
    ctr = lfsr(ctr),
    repeat the above operation until the iteration for i from 1 to 64 is
  completed; then compute the byte array IV from ctr using the following
  operation, IV = ctr,
  iterate i from 1 to 7:
    ctr = lfsr(ctr),
    IV = IV ∥ ctr,
    repeat the above operations until the iteration for i is completed;
  St = St₀, where St₀ represents the internal state subsequent to initialization;
  St = applyKeyOrIV(IV, 64, St, rom);
return St.
```

10. The encryption and decryption method using a stream cipher based on integer-oriented cryptographic permutations according to claim 9, wherein:
```
if the state refresh threshold srt > 0, then:
  St₀ = St,
  gctr = 0, where gctr is a word;
while the keystream generated by the keystream generation function has not reached a
predetermined length:
  if srt > 0,gctr > 0 and gctr % srt = 0, where the symbol % denotes a modulo operation,
  then:
    src = gctr ÷srt,
    St = refreshInternal State(St₀; rom; src);
regardless of whether gctr > 0 and gctr % srt = 0, perform the following operation:
  gctr = gctr + 1.
```
